(19) United States
(12) Patent Application Publication
(10) Pub. No.: US 2004/0045272 A1
(43) Pub. Date: Mar. 11, 2004

(54) Fluidized-bed gasification method and apparatus

(76) Inventors: Norihisa Miyoshi, Tokyo (JP); Seiichiro Toyoda, Tokyo (JP); Kei Matsuoka, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/451,727

(22) PCT Filed: Dec. 26, 2001
(86) PCT No.: PCT/JP01/11431

(30) Foreign Application Priority Data
Dec. 26, 2001 (JP) 2000-396319

(51) Int. Cl. F02C 3/28

(52) U.S. Cl. 60/39.12; 60/39.464

(57) ABSTRACT

The present invention relates to a method and apparatus for effectively utilizing thermal energy possessed by a high-temperature combustion gas discharged from a combustor and utilizing high-temperature oxygen contained in the high-temperature combustion gas discharged from the combustor. A fluidized-bed gasification apparatus for gasifying combustibles in a fluidized-bed furnace comprises a gasification furnace (2) for gasifying combustibles therein, and a combustion furnace (1) for combusting combustible components therein. The fluidized medium moves between the gasification furnace (2) and the combustion furnace (1), and exhaust gas discharged from another combustor is utilized as a fluidizing gas in the combustion furnace (1).

### TECHNICAL FIELD

The present invention relates to a method and apparatus for effectively utilizing thermal energy possessed by a high-temperature combustion gas discharged from a combustor and utilizing high-temperature oxygen contained in the high-temperature combustion gas discharged from the combustor, and more particularly to a gasification method and apparatus for utilizing thermal energy possessed by a high-temperature combustion gas and high-temperature oxygen contained in the high-temperature combustion gas to gasify combustibles in a fluidized-bed furnace. Here, combustibles to be gasified include at least one of heavy oil, coal, biomass, combustible wastes, and the like.

### BACKGROUND ART

In recent years, as a highly efficient power generation technology, a gas turbine combined-cycle power generation system which employs natural gas or the like as a fuel is becoming widespread. In the gas turbine combined-cycle power generation system, because gas turbine exhaust has a high temperature of 500 to 600° C. and air-fuel ratio is large, about 10 to 15% of oxygen remains in the combustion gas. In the conventional gas turbine combined-cycle power generation system, this exhaust is led to a boiler, and thermal energy of the exhaust is recovered as steam. However, oxygen in the exhaust gas heated to a high temperature is not utilized and is discharged from the system to the atmosphere.

In general, gasification of combustibles can be sufficiently carried out at a temperature of about 600 to 800° C., and then the gas produced by the gasification can be reformed into hydrogen and CO gas at a temperature of about 900° C. Further, if gasification of combustibles and reforming of the produced gas are carried out using a gasification catalyst and a reforming catalyst, respectively, then the gasification temperature and the reforming temperature can be lowered, respectively. Therefore, if combustibles are combusted by the residual oxygen contained in the gas turbine exhaust having a high-temperature sensible heat of 500 to 600° C. for thereby raising exhaust temperature and utilizing such raised temperature as a heat source of gasification, then an energy saving may be effectively performed. However, there has been no such suitable measures.

### DISCLOSURE OF INVENTION

The present invention has been made in view of the above, and it is therefore an object of the present invention to provide a fluidized-bed gasification method and apparatus which can effectively utilize thermal energy possessed by exhaust gas and high-temperature oxygen contained in the exhaust gas to gasify combustibles by using, as a fluidizing gas in a fluidized-bed combustion furnace, the exhaust gas discharged from a combustor of a gas turbine or the like in a gas turbine combined-cycle power generation system.

In order to achieve the above object, according to a first aspect of the present invention, there is provided a fluidized-bed gasification method for gasifying combustibles in a fluidized-bed furnace, comprising: supplying exhaust gas discharged from a gas turbine in a power generation system to a fluidized-bed furnace as a fluidizing gas.

According to a second aspect of the present invention, there is provided a fluidized-bed gasification apparatus for gasifying combustibles in a fluidized-bed furnace, comprising: a gasification furnace for gasifying combustibles therein; and a combustion furnace for combusting combustible components therein; wherein a fluidized medium moves between the gasification furnace and the combustion furnace, and exhaust gas discharged from another combustor is utilized as a fluidizing gas in the combustion furnace.

According to a third aspect of the present invention, there is provided fluidized-bed gasification apparatus for gasifying combustibles in a fluidized-bed furnace, comprising: a fluidized-bed furnace having a gasification chamber for gasifying combustibles therein and a char combustion chamber for combusting combustible components therein; and a partition wall for partitioning the gasification chamber and the char combustion chamber, the partition wall having an opening for allowing a fluidized medium to pass therethrough; wherein an upper end of the opening is lower than a height of a fluidized bed, and exhaust gas discharged from another combustor is utilized as a fluidizing gas for the char combustion chamber.

In a preferred aspect of the present invention, a reformer in which the product gas from the gasification chamber is reformed into H₂ and Co gases with sensible heat of the combustion gas from the combustion chamber is provided in the char combustion chamber.

In a preferred aspect of the present invention, the reformer is provided in a freeboard section of the char combustion chamber.

According to the present invention, the fluidized medium in the gasification furnace includes at least one of nickel-based catalyst, cobalt-molybdenum-based catalyst, various kinds of alkali metal, silica sand, quartz, α-alumina, FeSiO, and MgSiO which are formed into granular shape or are carried on carriers.

According to the present invention, a fluidized-bed furnace is utilized, and in the combustion region, combustion reaction by oxygen in the gas turbine exhaust having a lower concentration than that in air is accelerated by high material diffusion function of a fluidized bed, and heat generated in the combustion reaction is transferred to the gasification region by the fluidized medium as a heating medium for thereby effectively utilizing the heat generated by combustion reaction as heat required for gasification reaction. Heavy residual components such as tar or char generated in the pyrolysis and gasification reaction in the gasification region are carried into the combustion region by attaching the heavy residual components to the fluidized medium or carrying the heavy residual components together with the fluidized medium, and the fluidized medium to which the heavy residual components such as tar are attached is regenerated by combustion treatment in the combustion region for thereby protecting the gasification region from troubles caused by accumulation of tar components.

### BRIEF DESCRIPTION OF DRAWINGS

FIG. 1 is a schematic view showing a fundamental construction of a fluidized-bed gasification method and apparatus according to a first embodiment of the present invention;

FIG. 2 is a schematic view showing a fluidized-bed gasification method and apparatus according to a second embodiment of the present invention;

FIG. 3 is a schematic view showing a fluidized-bed gasification method and apparatus according to a third embodiment of the present invention; and

FIG. 4 is a block diagram of a gas turbine combined-cycle pow r generation system which incorporates the fluidized-bed gasification apparatus shown in FIG. 1.

### BEST MOD FOR CARRYING OUT THE INV NTION

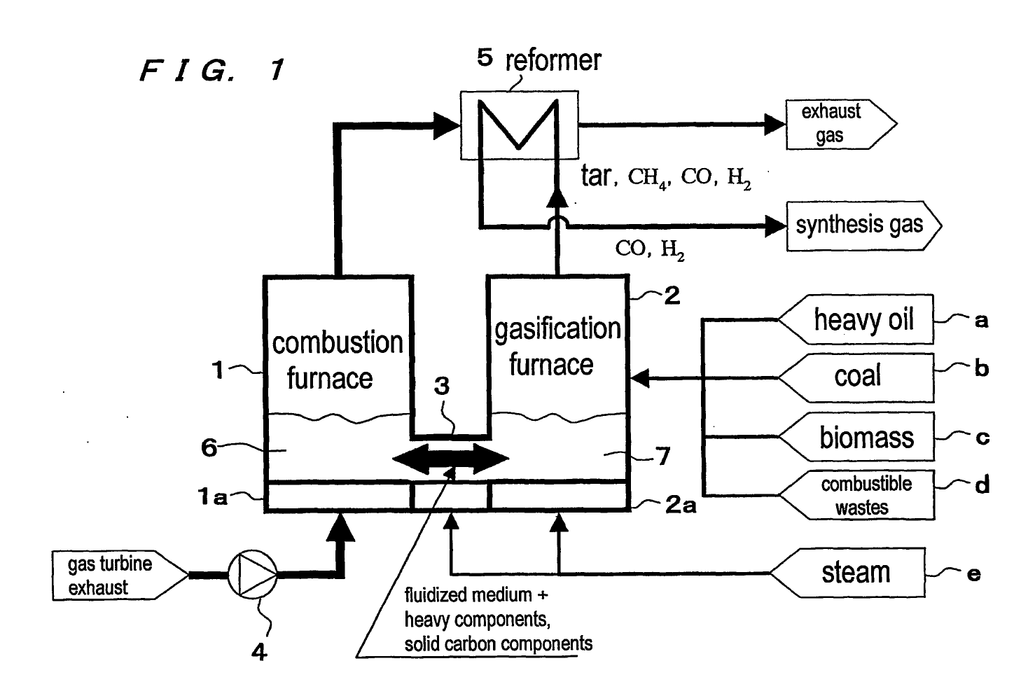

A fluidized-bed gasification method and apparatus according to embodiments of the present invention will be described below with reference to FIGS. 1 through 4.

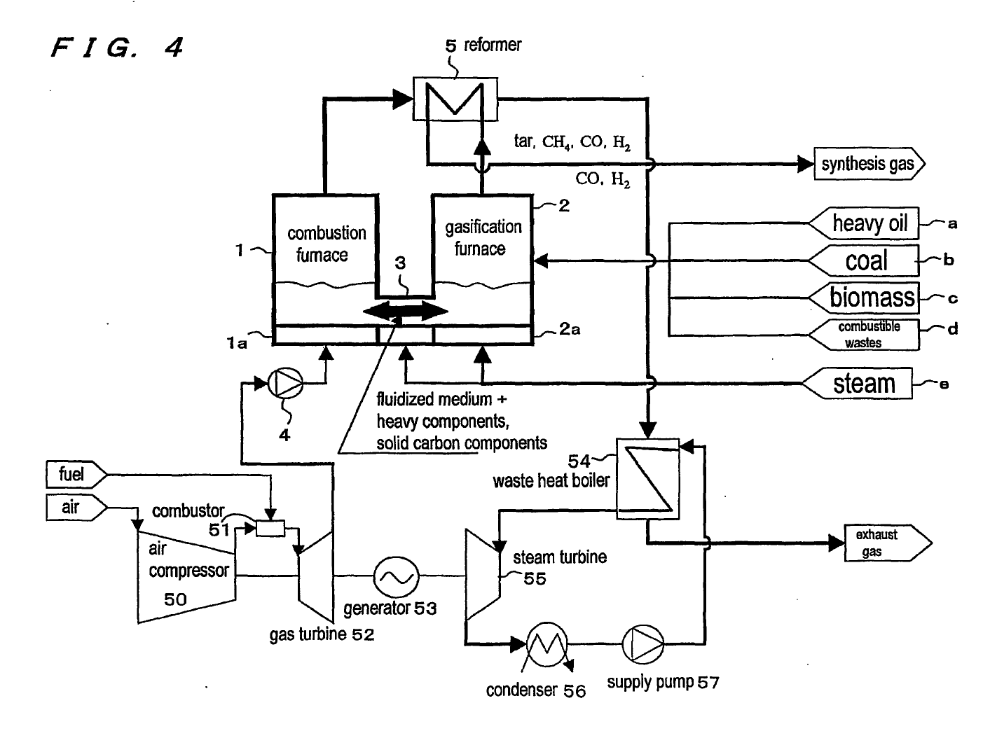

FIG. 1 schematically shows a fluidized-bed gasification method and apparatus according to a first embodiment of the present invention. As shown in FIG. 1, a gasification apparatus using a fluidized-bed comprises a fluidized-bed combustion furnace 1 and a fluidized-bed gasification furnace 2, and the fluidized-bed combustion furnace 1 is connected to the fluidized-bed gasification furnace 2 by a communicating pipe 3. In the fluidized-bed combustion furnace 1 and the fluidized-bed gasification furnace 2, a fluidized bed 6 and a fluidized bed 7 in which a fluidized medium such as silica sand is fluidized, respectively, are formed. A wind box 1a is provided at a lower portion of the fluidized-bed combustion furnace 1, and gas turbine exhaust is pressurized by a booster blower 4 and introduced into the wind box 1a. Specifically, the gas turbine exhaust discharged from a gas turbine 52 (see FIG. 4) in a gas turbine combined-cycle power generation system is utilized as a fluidizing gas for fluidizing the fluidized medium in the fluidized-bed combustion furnace 1 and as an oxidizing agent for combustion reaction which combusts combustible components in the fluidized-bed combustion furnace 1. The temperature of the gas turbine exhaust is in the range of 450 to 650° C, preferably 500 to 650° C., more preferably 600 to 650° C. The pressure which is pressurized by the booster blower 4 is generally 20 to 30 kPa, and if the back pressure of about 20 to 30 kPa is allowable in the gas turbine process, then the booster blower 4 is unnecessary.

The fluidized medium which has been heated by the gas turbine exhaust in the fluidized-bed combustion furnace 1 is diffused in the communicating pipe 3 and moved through the communicating pipe 3, and then reaches the fluidized-bed gasification furnace 2 for thereby heating the fluidized medium in the fluidized-bed gasification furnace 2. At least one of heavy oil a, coal b, biomass c and combustible wastes d is supplied to the fluidized-bed gasification furnace 2 as materials to be gasified. A wind box 2a is provided at a lower portion of the fluidized-bed gasification furnace 2, and steam e is supplied to the wind box 2a as a fluidizing gas and a gasifying agent. The materials to be gasified are pyrolyzed and gasified by sensible heat of the fluidized medium which has moved from the fluidized-bed combustion furnace 1 to the fluidized-bed gasification furnace 2, thus producing combustible gas containing heavy components such as tar. This combustible gas is composed of tar, hydrocarbon such as CH₄. CO, H₂, and the like. The fluidizing gas and the gasifying agent in the fluidized-bed gasification furnace 2 are not limited to steam, other gases may be used, and particularly carbon dioxide and synthesis gas produced by this process may be effective.

Further, if necessary, air or oxygen may be supplied to the fluidized-bed gasification furnace 2 to elevate the temperature of the gasification furnace. Particularly, it is effective to warm the fluidized-bed gasification furnace 2 by supplying air or oxygen during starting of the fluidized-bed gasification furnace 2. In the case where oxygen or oxygen-containing gas is supplied to the fluidized-bed gasification furnace 2, it is necessary not to generate agglomeration due to poor fluidization. Further, it is effective to supply a fluidizing gas to the communicating pipe 3 to accelerate movement of the fluidized medium. Although this fluidizing gas is preferably the same gas as the fluidizing gas in the fluidized-bed gasification furnace 2, a fluidizing gas which is the same gas as the fluidizing gas in the fluidized-bed combustion furnace 1 may be supplied to the communicating pipe 3, or other gases may be supplied.

Among materials to be gasified, components which do not become gaseous in the fluidized-bed gasification furnace 2 and do remain in the gasification furnace, for example, heavy tar component, char component, or ash content are diffused together with the fluidized medium in the communicating pipe 3 and are moved toward the fluidized-bed combustion furnace 1. Combustible components such as tar component and char component which have flowed in the fluidized-bed combustion furnace 1 are combusted by the residual oxygen in the gas turbine exhaust in the fluidized-bed combustion furnace 1, and contribute to raise the temperature of the fluidized-bed combustion furnace 1. By this combustion, the fluidized medium to which tar or the like is attached is regenerated to its original condition, and hence poor fluidization of the fluidized medium caused by adhesiveness of tar component in the fluidized-bed gasification furnace 2 can be avoided. Further, even if catalysts having a function of accelerating gasification or accelerating gas reforming are used as a fluidized medium, lowering of catalytic function caused by tar or the like which covers the surface of the catalyst can be prevented.

Combustible components are supplied from the fluidized-bed gasification furnace 2 to the fluidized-bed combustion furnace 1, and hence the temperature in the fluidized-bed combustion furnace 1 is kept in the range of 600 to 1000° C., preferably 600 to 900° C., and more preferably 600 to 800° C. As the temperature in the fluidized-bed combustion furnace 1 is raised, the temperature in the fluidized-bed gasification furnace 2 which is heated by heat transfer and thermal diffusion from the combustion furnace is also raised. Therefore, the temperature in the fluidized-bed gasification furnace 2 is kept in the range of 550 to 900° C., pref rably 550 to 750° C., and more preferably 550 to 650° C. The reason why the temperature in the fluidiz d-bed gasification furnace 2 is preferably lower is that if the quantity of combustible components which are combusted in the combustion furnace is reduced as much as possible, the exergy loss is small and the energy saving effect is heighten. Although it is desirable that the gasification process of the present invention can be realized only by sensible heat of the gas turbine exhaust, i.e. any combustion reaction of combustible components is required for supplying the heat required for gasification reaction, if the necessity of regeneration or the like of the fluidized medium to which the above-mentioned tar is attached is considered, then it is desirable to cause combustion reaction to some extent in the combustion furnace.

If it is possible to lower the reaction temperature of gasification by using catalyst or the like, then the necessity of heating in the combustion furnace is lowered, and hence it is not necessary to treat the whole amount of the gasification reactant residue by combustion. Therefore, it is possible to recover the gasification residue produced in the gasification furnace. In the case where materials to be gasified comprises biomass or subbituminous coal or the like, carbonous materials can be recovered from the gasificationfurnace. Particularly, if reforming catalyst is used as a fluidized medium, because tar is decomposed, high quality carbonous materials can be recovered. When steam is used as a fluidizing gas in the gasification furnace, adsorption and activation of carbonous materials can be enhanced by activation effect with steam. It should be noted that carbonous materials can be recovered from other combustible materials such as wastes.

In this gasification process, because the combustion reaction takes place only in the fluidized-bed combustion furnace 1, the temperature of exhaust gas discharged from the fluidized-bed combustion furnace 1 is higher than the temperature of produced gas discharged from the fluidized-bed gasification furnace 2. Therefore, the exhaust gas discharged from the fluidized-bed combustion furnace 1 and the produced gas discharged from the fluidized-bed gasification furnace 2 are supplied, respectively, to a reformer 5, and the produced gas produced by the fluidized-bed gasification furnace 2 can be reformed with sensible heat of the combustion gas discharged from the fluidized-bed combustion furnace 1 in indirect heat exchange manner. The reformer 5 preferably comprises a shell and tube-type heat exchanger (tubular type heat exchanger), and the produced gas is passed through the interior of the pipe and the combustion gas flows along the exterior of the pipe. It is desirable that the interior of the pipe is packed with noble metal-based reforming catalyst such as platinum or Ni, or metal oxide reforming catalyst such as iron oxide or alumina-based catalyst. The combustion gas and the produced gas are preferred to be introduced into dust collectors, respectively, to remove dust in the gases, before they are introduced into the reformer 5. This dust removal is effective in avoiding clogging troubles in the reformer 5. The reformer 5 may be provided in the fluidized-bed combustion furnace 1, and is preferably installed in a freeboard section of the combustion furnace 1.

In this manner, the gas turbine exhaust which has been effectively utilized in the combustion reaction and reduces its oxygen concentration, is released to the atmosphere, after heat recovery by a waste heat boiler or the like as in the conventional manner. Further, combustible gas components in the produced gas are reformed into hydrogen and CO in the reformer 5, and the reformed gas is effectively utilized as materials for chemical industry or cracking agent.

Although the gas turbine exhaust is utilized as a gas containing high-temperature oxygen in the above description, it should be noted that similar exhaust gas, i. any exhaust gas may be utilized as far as such exhaust gas has sensible heat as high temperature and contains oxygen. As an example, a cathode exhaust gas discharged from a high-temperature operating-type fuel cell such as a solid oxide fuel cell (SOFC), or a molten carbonate fuel cell (MCFC) can be utilized as with the gas turbine exhaust.

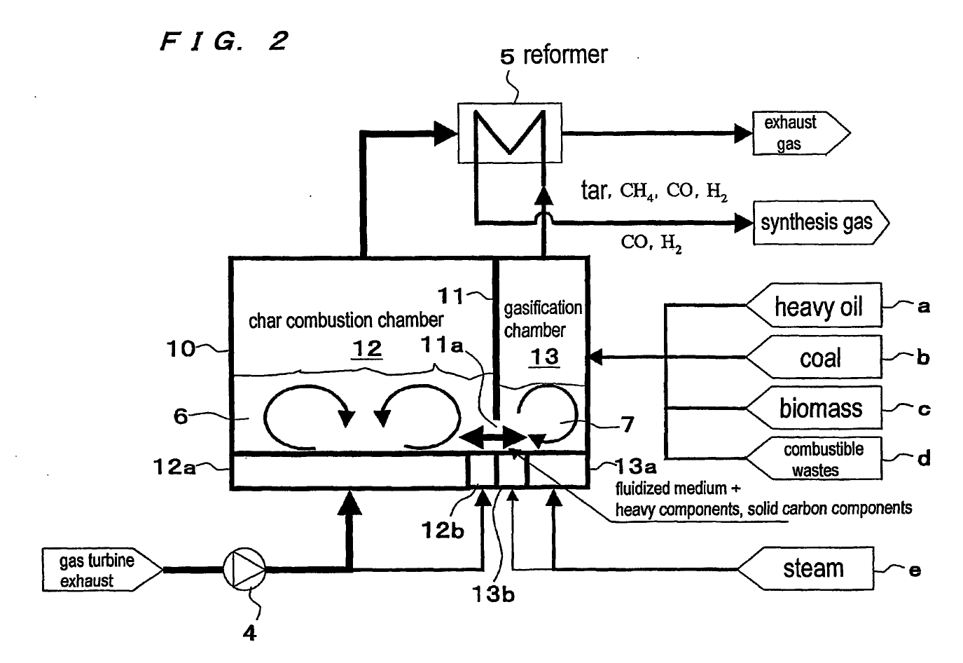

FIG. 2 is a schematic view showing the construction of the second embodiment of the present invention. In the embodiment shown in FIG. 1, the combustion furnace and the gasification furnace are connected to each other through the communicating pipe. According to the present embodiment shown in FIG. 2, an integrated-type gasification furnace in which combustion region and gasification region are coexistent in a single furnace is utilized. As shown in FIG. 2, the integrated-type gasification furnace 10 comprises a char combustion chamber 12 and a gasification chamber 13 which are partitioned by a partition wall 11. In the char combustion chamber 12 and the gasification chamber 13, a fluidized bed 6 and a fluidized bed 7 in which fluidized medium such as silica sand is fluidized, respectively, are formed. An opening 11a is formed in the partition wall 11 in the vicinity of the furnace bottom, and the fluidized medium can move freely between the char combustion chamber 12 and the gasification chamber 13 through the opening 11a. A wind box is provided below the char combustion chamber 12, and the gas turbine exhaust can be supplied to this wind box as a fluidizing gas and an oxidizing agent. The wind box is divided into a wind box 12b near the opening 11a and a wind box 12a other than the wind box 12b, and the amount of gas supplied to the respective wind boxes 12a, 12b can be independently controlled.

A wind box is provided below the gasification chamber 13, and steam or carbon dioxide can be supplied to this wind box as a fluidizing gas and a gasifying agent. As with the first embodiment, if necessary, air or oxygen may be supplied to the gasification chamber 13 to elevate the temperature of the gasification chamber 13. This wind box is also divided into a wind box 13b near the opening 11a and a wind box 13a other than the wind box 13b, and the amount of gas supplied to the respective wind boxes 13a, 13b can be independently controlled.

The amount of the fluidized medium which moves between the char combustion chamber 12 and the gasification chamber 13 can be positively controlled by controlling the amount of the fluidizing gas supplied to the respective wind boxes 12b and 13b of the char combustion chamber 12 and the gasification chamber 13. Specifically, by intensifying or weakening fluidization of the fluidized medium, the amount of the fluidized medium which moves between the char combustion chamber 12 and the gasification chamber 13 can be increased or decreased. However, if the fluidization of the fluidized medium in the combustion chamber is excessively weakened, thermal diffusion becomes insufficient for maintaining uniform temperature in the combustion chamber, and hence there is a high possibility that the temperature in the local area where the fluidization of the fluidized medium is weakened becomes high and agglomeration trouble occurs. Therefore, care should be given to avoid such trouble. Thus, the wind box at the combustion chamber side is not required to be divided, but the wind box at the gasification chamber side should be divided.

As shown in FIG. 2, it is preferable that an internally circulating flow of the fluidized medium is created to mix the fluidized medium in the fluidized bed uniformly, by forming intense fluidizing region and weak fluidizing region in the combustion chamber. By providing intensiveness and weakness of fluidization positively, the region of weak fluidization, i.e. the region where the amount of oxidizing agent supplied thereto is small is in an oxygen shortage condition, relatively, and hence nitrogen oxides contained in the gas turbine exhaust can be reduced by OH radical or the like generated in such region. In order to accelerate distribution of materials to be gasified in the fluidized bed, it is important for the gasification chamber 13 also to provide intensiveness and weakness of fluidization of the fluidized medium. The intensiveness and weakness of fluidization of the fluidized medium may be provided by the method in which the wind box is divided into a plurality of wind boxes and the amount of the fluidizing gas supplied to the respective wind boxes is controlled, or the method in which the size of blowout holes in air diffusion nozzles is varied in the case where specific and independent control of the amount of fluidizing gases supplied to each of intense fluidizing region and weak fluidizing region is not required. The reformer 5 may be provided in the char combustion chamber 12, and is preferably installed in a freeboard section of the char combustion chamber 12. Other structural details in the second embodiment are the same as those in the first embodiment.

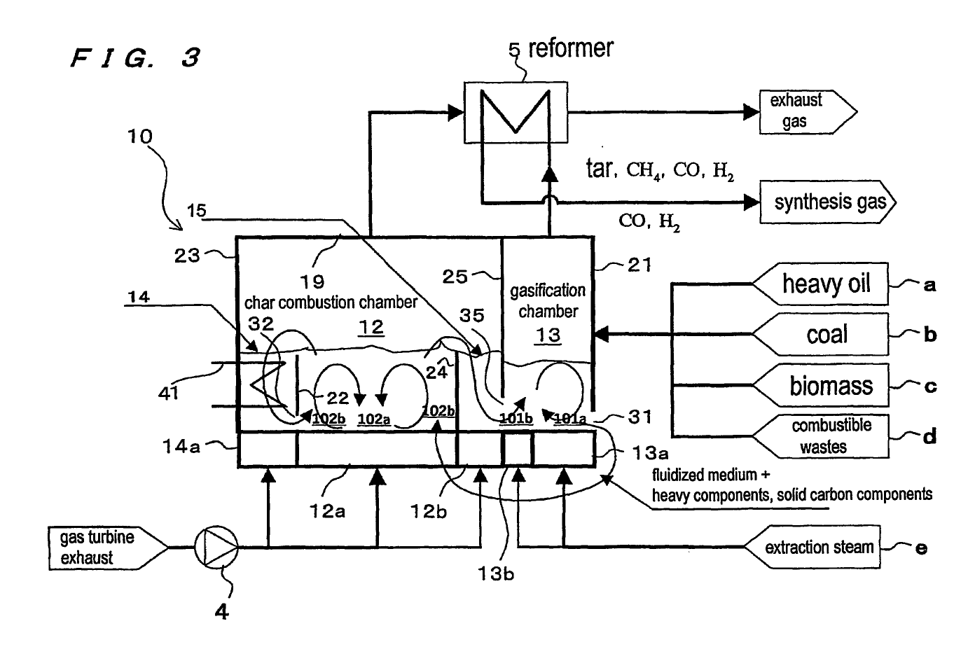

FIG. 3 is a schematic view showing the structure of the third embodiment of the present invention. In the third embodiment shown in FIG. 3, the movement of the fluidized medium between the combustion region and the gasification region can be controlled more positively than that of the second embodiment shown in FIG. 2. In this embodiment also, an integrated-type gasification furnace in which combustion region and gasification region are coexistent in a single furnace is utilized.

As shown in FIG. 3, the integrated-type gasification furnace 10 comprises a gasification chamber 13, a char combustion chamber 12 and a heat recovery chamb r 14 which have three functions of pyrolysis or gasification, combustion of char, and heat recov ry, respectively. All chambers 12, 13 and 14 are accommodated in a furnace body which has a cylindrical shape or a rectangular shape or other shapes. The gasification chamber 13, the char combustion chamber 12 and the heat recovery chamber 14 are partitioned by partition walls 21, 22, 23, 24 and 25, and a fluidized bed containing a fluidized medium which is a dense bed is formed at the respective lower portions in the chambers. In order to fluidize the fluidized medium in the respective fluidized beds within the respective chambers, i.e. the gasification chamber fluidized bed, the char combustion chamber fluidized bed and the heat recovery chamber fluidized bed, wind boxes 12a, 12b; 13a, 13b; 14a are provided below the respective chambers 12, 13 and 14 to supply a fluidizing gas into the fluidized medium. The superficial velocity of a fluidizing gas supplied from the wind box is different from each other in respective areas in the chamber, and hence fluidization state of the fluidized medium is also different from each other in the respective areas in the chamber. Therefore, an internally circulating flow of the fluidized medium is formed in the respective chambers.

The gasification chamber 13 and the char combustion chamber 12 are partitioned by a partition wall 21, and the char combustion chamber 12 and the heat recovery chamber 14 are partitioned by a partition wall 22, and the gasification chamber 13 and the heat recovery chamber 14 are partitioned by a partition wall 23. Specifically, the furnace is not constructed discrete furnaces, but is constructed as a single integral furnace. Further, a fluidized medium moving chamber 15 is provided to allow the fluidized medium to descend at the location where the char combustion chamber 12 faces the gasification chamber 13. That is, the char combustion chamber 12 is divided into the fluidized medium moving chamber 15 and a char combustion chamber main section other than the fluidized medium moving chamber 15. Therefore, a partition wall 24 is provided to partition the fluidized medium moving chamber 15 from the char combustion chamber main section. Further, the fluidized medium moving chamber 15 and the gasification chamber 13 are partitioned by a partition wall 25.

Next, concept and definition of the “interface” in the fluidized bed will be described. The fluidized bed comprises a dense bed located at a vertically lower portion and densely containing a fluidized medium such as silica sand which is in a fluidization state by a fluidizing gas, and a splash zone, located above the dense bed in a vertical direction, in which the fluidized medium and a large amount of gases are coexistent and the fluidized medium ascends vigorously. Above the fluidized bed, i.e. above the splash zone, there is provided a freeboard section which contains gases mainly and almost no fluidized medium. In the present invention, the interface means the above splash zone having a certain thickness, or an imaginary plane located intermediately between the upper surface of the splash zone and the lower surface of the splash zone (i.e. the upper surface of the dense bed).

Furthermore, with respect to a statement “chambers are partitioned each other by a partition wall in a location above the interface of a fluidized bed, so that no gases flow between the chambers”, it is preferable that no gases flow between the chambers in the location above the upper surface of he dense bed located below the interface.

The partition wall 21 between the gasification chamber 13 and the char combustion chamber 12 extends from the top 19 of the furnace toward the bottom (perforated plate of the diffuser) of the furnace, and the lower end of the partition wall 21 does not contact the furnace bottom so that a second opening 31 is formed in the vicinity of the furnac bottom. However, the upper end of the opening 31 does not reach a location above both the gasification chamber fluidized bed interface and the char combustion chamber fluidized bed interface. More preferably, the upper end of the opening 31 does not reach a location above both the upper surface of the dense bed in the gasification chamber fluidized bed and the upper surface of the dense bed in the char combustion chamber fluidized bed. In other words, preferably, the opening 31 is always buried in the dense bed. Specifically, the gasification chamber 13 and the char combustion chamber 12 are partitioned by the partition wall at least in the freeboard section, preferably in the location above the interface, and more preferably in the location above the upper surface of the dense bed so that no gases flow between the gasification chamber 13 and the char combustion chamber 12.

The upper end of the partition wall 22 between the char combustion chamber 12 and the heat recovery chamber 14 is located in the vicinity of the interface, i.e. at the location above the upper surface of the dense bed, but below the upper surface of the splash zone. The lower end of the partition wall 22 is located in the vicinity of the furnace bottom, but does not contact the furnace bottom in the same manner as the partition wall 21. Therefore, an opening 32 which does not reach a location above the upper surface of the dense bed is formed in the vicinity of the furnace bottom.

The partition wall 23 between the gasification chamber 13 and the heat recovery chamber 14 extends from the top to the bottom of the furnace so that the gasification chamber 13 and the heat recovery chamber 14 are fully partitioned by the partition wall 23. The upper end of the partition wall 24 which partitions the char combustion chamber 12 to provide the fluidiz d medium moving chamber 15 is located in the vicinity of the interface of the fluidized bed, and the lower end of the partition wall 24 contacts the furnace bottom. The relationship between the upper end of the partition wall 24 and the fluidized bed is the same as the relationship between the upper end of the partition wall 22 and the fluidized bed. The partition wall 25 for partitioning the fluidized medium moving chamber 15 and the gasification chamber 13 extends from the top toward the bottom of the furnace, and the lower end of the partition wall 25 does not contact the furnace bottom so that a first opening 35 is formed in the vicinity of the furnace bottom. The upper end of the opening 35 is located below the upper surface of the dense bed. Specifically, the relationship between the first opening 35 and the fluidized bed is the same as the relationship between the second opening 31 and the fluidized bed.

The fuel such as heavy oil, biomass, coal or wastes supplied to the gasification chamber receives heat from the fluidized medium, and is pyrolyzed and gasified. Typically, the fuel is not combusted in the gasification chamber, the so-called dry distillation of the fuel is performed. Char produced by the dry distillation flows together with the fluidized medium from the gasification chamber 13 into the char combustion chamber 12 through the opening 31 located at the lower portion of the partition wall 21. In this manner, the char introduced from the gasification chamber 13 is combusted in the char combustion chamber 12 to thus heat the fluidized medium. The fluidized medium heated by heat generated by combustion reaction of char in the char combustion chamber 12 enters the heat recovery chamber 14 beyond the upper end of the partition wall 22, and heat possessed by the heated fluidized medium is transferred to heat transfer tubes 41 disposed below the interface in the heat recovery chamber 14. Thus, the fluidized medium is cooled, and the cooled fluidized medium flows again into the char combustion chamber 12 through the opening 32 formed in the partition wall 22.

Volatile components of the combustibles supplied to the gasification chamber 13 are instantaneously gasified, and then solid carbon components (char) are relatively sluggishly gasified. Therefore, the residence time of char in the gasification chamber 13, i.e. the time for allowing char supplied to the gasification chamber 13 to enter the char combustion chamber 12 through the gasification chamber 13 is an important factor for determining the rate of gasification (carbon conversion) of the fuel.

In case of using silica sand or the like as a fluidized medium, since the specific gravity of char is smaller than that of the fluidized medium, char is concentratedly accumulated in the upper part of the fluidized bed. In the case where the furnace has such a structure that the fluidized medium flows into the gasification chamber and flows out of the gasification chamber to the char combustion chamber through the opening formed in the lower portion of the partition wall, the fluidized medium which is present mainly in the lower part of the fluidized bed flows from the gasification chamber to the char combustion chamber more easily than the char which is present in the upper part of the fluidized bed. Conversely, char is hard to flow from the gasification chamber to the char combustion chamber. Therefore, it is possible for char to maintain average residence time longer in the gasification chamber, compared with a gasification chamber with completely mixed fluidizing status. In this case, the fluidized medium which has flowed from the fluidized medium moving chamber 15 into the gasification chamber is not distributed widely in the gasification chamber, and the fluidized medium passes mainly through the lower part of the gasification chamber and enters the char combustion chamber. In such case, heat exchange between the fluidizing gas supplied from the furnace bottom of the gasification chamber and the fluidized medium is performed, and then heat transfer from the fluidizing gas to char follows, and hence heat required for gasification reaction of char can be indirectly supplied from sensible heat of the fluidized medium.

Further, the velocity of the fluidizing gas in the gasification chamber is controlled, and the condition of the circulating flow of the fluidized medium in the gasification chamber is controlled, whereby the mixing state of the fluidized medium and char in the gasification chamber can be varied and the average residence time of char in the gasification chamber can be controlled.

On the other hand, in this furnace having the above structure, by controlling the differential pressure between the gasification chamber and the char combustion chamber, the height of the fluidized bed in the gasification chamber can be freely varied, and consequently the residence time of char in the gasification chamber can be controlled.

Here, the heat recovery chamber 14 is not essential in the gasification system of fuel according to the present invention. Specifically, if the amount of char which is mainly composed of carbon and remains in the gasification chamber 13 after gasification of volatile components is substantially equal to the amount of char required for heating the fluidized medium in the char combustion chamber 12, then the heat recovery chamber 14 which deprives heat from the fluidized medium is unnecessary.

However, in the case where the furnace is provided with the heat recovery chamber 14 as shown in FIG. 3, such furnace can deal with a wide range of fuel from coal which produces a large amount of char to heavy oil which produces a trace amount of char. That is, even in any fuel, by controlling the quantity of heat recovered in the heat recovery chamb r 14, the combustion temperature in the char combustion chamber 12 can be properly adjusted, and the temperature of the fluidized medium can be properly maintained.

The fluidized medium heated in the char combustion chamber 12 enters the fluidized medium moving chamber 15 beyond the upper end of the partition wall 24, and then flows into the gasification chamber 13 through the opening 35 located at the lower portion of the partition wall 25.

Next, the fluidization state and movement of the fluidized medium between the respective chambers will be described below.

An intense fluidizing region 101b in which fluidization of the fluidized medium is maintained more intensely than fluidization of the fluidized medium in the fluidized medium moving chamber 15 is formed at the location near the partition wall 25 in the gasification chamber 13. It is desirable that superficial velocity in the fluidizing gas is changed depending on the locations so that mixing and diffusion of the supplied fuel and the fluidized medium can be accelerated wholly. As an example, as shown in FIG. 3, a circulating flow of the fluidized medium is formed by providing a weak fluidizing region 101a besides the intense fluidizing region 101b.

The char combustion chamber 12 has a weak fluidizing region 102a at a central region thereof, and an intense fluidizing region 102b at a peripheral region thereof, and an internally circulating flow of the fluidized medium and char is created in the char combustion chamber 12. The fluidizing velocity in the intense fluidizing region of the gasification chamber 13 and the char combustion chamber 12 is preferably 5 Umf or more, and the fluidizing velocity in the weak fluidizing region of the gasification chamber 13 and the char combustion chamber 12 is preferably 5 Umf or less. If there is provided a distinct difference between the fluidizing velocity in the weak fluidizing region and the fluidizing velocity in the intense fluidizing region, then the fluidizing velocity exceeding the above range may be allowed. The intense fluidizing region 102b is preferably provided at the locations near the heat recovery chamber 14 and the fluidized medium moving chamber 15 in the char combustion chamber 12. Further, if necessary, the furnace bottom is so inclined as to descend from the weak fluidizing region to the intense fluidizing region. Here, Umf is a unit of fluidization, and the minimum fluidization velocity (the velocity in which fluidization is started) is 1 Umf. That is, 5 Umf is 5 times the minimum fluidization velocity.

In this manner, by maintaining fluidization state of the region in the char combustion chamber 12 close to the partition wall 22, by which the char combustion chamber 12 and the heat recovery chamber 14 are separated, more intensely than fluidization state at the region near the partition wall 22 in the heat recovery chamber 14, the fluidized medium flows from the char combustion chamber 12 to the heat recovery chamber 14 beyond the upper end of the partition wall 22 located near the interface of the fluidized bed. The fluidized medium which has entered the heat recovery chamber 14 moves downwardly (toward the furnace bottom direction) because of relatively weak fluidization state in the heat recovery chamber 14, i.e. high density state, and then moves from the heat recovery chamber 14 to the char combustion chamber 12 through the opening 32 of the partition wall 22 located in the vicinity of the furnace bottom.

Similarly, by maintaining fluidization state of the region in the main section of the char combustion chamber close to the partition wall 24, by which the char combustion chamber main section and the fluidized medium moving chamber 15 are separated, more intensely than fluidization state in the fluidized medium moving chamber 15, the fluidized medium flows from the char combustion chamber main section to the fluidized medium moving chamber 15 beyond the upper end of the partition wall 24 located near the interface of the fluidized bed. The fluidized medium which has entered the fluidized medium moving chamber 15 moves downwardly (toward the furnace bottom direction) because of relatively weak fluidization state in the fluidized medium moving chamber 15, i.e. high density state, and then moves from the fluidized medium moving chamber 15 to the gasification chamber 13 through the opening 35 of the partition wall 25 located in the vicinity of the furnace bottom. Fluidization state of the fluidized medium at the location near the partition wall 25 between the gasification chamber 13 and the fluidized medium moving chamber 15 in the gasification chamber 13 is kept more intensely than fluidization state of the fluidized medium in the fluidized medium moving chamber 15. Thus, movement of the fluidized medium from the fluidized medium moving chamber 15 to the gasification chamber 13 is assisted by inducing function.

Similarly, fluidization state of the fluidized medium at the location near the partition wall 21 between the gasification chamber 13 and the char combustion chamber 12 in the char combustion chamber 12 is kept more intensely than fluidization state of the fluidized medium at the location near the partition wall 21 in the gasification chamber 13. Therefore, the fluidized medium flows into the char combustion chamber 12 through the opening 31 of the partition wall 21 located below the interface of the fluidized medium, preferably below the upper surface of the dense bed (buried in the dense bed).

In general, with regard to movement of the fluidized medium between the two chambers A and B, when the chambers A and B are partitioned by a partition wall X whose upper end is located in the vicinity of the interface, if fluidization state of the fluidized medium in the chamber A is kept more intensely than fluidization state of the fluidized medium in the chamber B, then the fluidized medium flows from the chamber A to the chamber B beyond the upper end of the partition wall X. Further, when the chambers A and B are partitioned by a partition wall Y whose lower end is located below the interface, preferably below the upper surface of the dense bed (buried in the dense bed), in other words, the chambers A and B are partitioned by the partition wall Y having an opening located below the interface or buried in the dense bed, by comparing fluidization state of the fluidized medium at the respective locations near the partition wall Y in the chamber A and the chamber B, if the fluidization state of the fluidized medium in the chamber A is kept more intensely than the fluidization state of the fluidized medium in the chamber B, the fluidized medium flows from the chamber B to the chamber A through the opening formed at the lower end of the partition wall. It can be said that this is caused by the inducing function of the relatively intense fluidization state of the fluidized medium in the chamber A or by the fact that the density of the fluidized medium in the chamber B in which a relatively weak fluidization state of the fluidized medium is formed is higher than the density of the fluidized medium in the chamber A in which a relatively intense fluidization state of the fluidized medium is formed. In some cases, a movement of the fluidized medium between the chambers made in a certain location causes other movements of the fluidized medium between the chambers in other locations so as to keep equilibrium state of mass balance between the chambers.

Further, with regard to the relative relationship between the upper end of the partition wall X as a partition wall for defining a chamber or a partition wall provided in a chamber and the lower end of the partition wall Y as a partition wall for defining a chamber or a partition wall provided in a chamber, the upper end of the partition wall X which allows the fluidized medium to move beyond the upper end thereof is higher in a vertical direction than the lower end of the partition wall Y which allows the fluidized medium to move under the lower end thereof. With this arrangement, when the fluidized medium is charged into the chamber and fluidized therein, if the amount of the fluidized medium charged therein is properly determined, the upper end of the partition wall X can be set to be located in the vicinity of the interface of the fluidized bed and the lower end of the partition wall Y can be set to be buried in the dense bed. If the intensity of fluidization of the fluidized medium near the partition wall is properly set as described above, the fluidized medium can be moved in a desired direction with respect to the partition wall X or the partition wall Y. Further, the gas flow between the two chambers partitioned by the partition wall Y can be eliminated.

Next, the case where the above analysis is applied to the embodiment of FIG. 3 will be described below. The char combustion chamber 12 and the heat recovery chamber 14 are partitioned by the partition wall 22 whose upper end is located in the vicinity of the interface and whose lower end is buried in the dense bed, and fluidization state of the fluidized medium at the location near the partition wall 22 in the char combustion chamber 12 is kept more intensely than fluidization state of the fluidized medium at the location near the partition wall 22 in the heat recovery chamber 14. Therefore, the fluidized medium flows from the char combustion chamber 12 to the heat recovery chamber 14 beyond the upper end of the partition wall 22, and moves from the heat recovery chamber 14 to the char combustion chamber 12 under the lower end of the partition wall 22.

Further, the char combustion chamber 12 and the gasification chamber 13 are partitioned by the partition wall 25 whose lower end is buried in the dense bed. At the char combustion chamber side of the partition wall 25, the fluidized medium moving chamber 15 is defined by the partition wall 24 whose upper end is located in the vicinity of the interface and the partition wall 25. Fluidization state of the fluidized medium at the location near the partition wall 24 in the char combustion chamber main section is kept more intensely than fluidization state of the fluidized medium at the location near the partition wall 24 in the fluidized medium moving chamber 15. Therefore, the fluidized medium flows from the char combustion chamber main section to the fluidized medium moving chamber 15 beyond the upper end of the partition wall 24. With this arrangement, the fluidized medium which has flowed in the fluidized medium moving chamber 15 moves from the fluidized medium moving chamber 15 to the gasification chamber 13 under the lower end of the partition wall 25 so as to keep mass balance at least. At this time, if fluidization state of the fluidized medium at the location near the partition wall 25 in the gasification chamber 13 is kept more intensely than fluidization state of the fluidized medium at the location near the partition wall 25 in the fluidized medium moving chamber 15, then movement of the fluidized medium is accelerated by the inducement action.

Further, the gasification chamber 13 and the char combustion chamber main section are partitioned by the partition wall 21 whose lower end is buried in the dense bed. The fluidized medium which has flowed from the fluidized medium moving chamber 15 to the gasification chamber 13 moves to the char combustion chamber 12 under the lower end of the partition wall 21 so as to keep mass balance. At this time, if fluidization state of the fluidized medium at the location near the partition wall 21 in the char combustion chamber 12 is kept more intensely than fluidization state of the fluidized medium at the location near the partition wall 21 in the gasification chamber 13, the fluidized medium is induced not only by keeping of mass balance but also by intense fluidization state and moves to the char combustion chamber 12.

In the embodiment shown in FIG. 3, the fluidized medium descends in the fluidized medium moving chamber 15 as a part of the char combustion chamber 12. However, the same structure may be provided in a part of the gasification chamber 13, more specifically in the location of the opening 31 in the form of a descending gasification chamber (not shown). Specifically, fluidization state of the fluidized medium in the descending gasification chamber is made to be weaker than fluidization state of the fluidized medium in the gasification chamber main section, and the fluidized medium flows from the gasification chamber main section to the descending gasification chamber beyond the upper end of the partition wall, and the fluidized medium which has descended moves to the char combustion chamber through the opening 31. At this time, the fluidized medium moving chamber 15 may be provided together with the descending gasification chamber, or may not be provided. If the descending gasification chamber is provided, the fluidized medium moves from the char combustion chamber 12 to the gasification chamber 13 through the opening 35, and the fluidized medium moves from the gasification chamber 13 to the char combustion chamber 12 through the opening 31.

In the heat recovery chamber 14, the fluidized medium is fluidized uniformly throughout the chamber, and fluidization state of the fluidized medium is normally maintained more weakly than fluidization state of the fluidized medium in the char combustion chamber 12 adjacent to the heat recovery chamber 14. Therefore, the superficial velocity in the fluidizing gas in the heat recovery chamber 14 is controlled in the range of 0 to 3 Umf, and the fluidized medium is sluggishly fluidized to form a descending fluidized bed. Here, 0 Umf means the state in which the supply of the fluidizing gas is stopped. In such state, heat recovery in the heat recovery chamber 14 can be minimized. Specifically, in the heat recovery chamber 14, by changing fluidization state of the fluidized medium, the quantity of recovered heat can be freely adjusted in the range from the maximum to the minimum. In the heat recovery chamber 14, fluidization of the fluidized medium may be equally changed in the entire chamber, or changed in a part of the chamber. For example, fluidization may be equally started or stopped, or adjusted to certain intensity in the entire chamber. Otherwise, fluidization state may be stopped in a part of the chamber and continued in other parts of the chamber, or adjusted to certain intensity only in a part of chamber.

The partition wall between the chambers is basically a vertical wall, but an inclined portion may be provided in the partition wall, if necessary. In this construction, the flow direction of the fluidized medium can be corrected in the vicinity of the partition wall, and formation of the internally circulating flow of the fluidized medium can be promoted. Further, relatively large incombustibles contained in fuel are discharged from an incombustible discharge port (not shown) provided at the furnace bottom of the gasification chamber 13. Furthermore, the bottom surfaces in the respective chambers may be horizontal, but may be inclined along the flow of the fluidized medium near the furnace bottom so as not to form stagnated areas in the flow of the fluidized medium.

The incombustible discharge port may be provided not only at the furnace bottom of the gasification chamber 13, but also at the furnace bottom of the char combustion chamber 12 or the heat recovery chamber 14.

In the integrated-type gasification furnace 10 according to the embodiment shown in FIG. 3, three chambers comprising a gasification chamber, a char combustion chamber and a heat recovery chamber are provided by partition walls in a single fluidized-bed furnace, and the char combustion chamber and the gasification chamber are provided adjacent to each other and the char combustion chamber and the heat recovery chamber are provided adjacent to each other. In the integrated-type gasification furnace 10, because a large amount of the fluidized medium can be circulated between the char combustion chamber and the gasification chamber, required heat for gasification reaction can be sufficiently supplied only by sensible heat of the fluidized medium.

By using the integrated-type gasification furnace according to the present invention, since a large amount of the fluidized medium can be freely circulated, the apparatus can be downsized. Other structural details according to the third embodiment shown in FIG. 3 are the same as those of the first embodiment shown in FIG. 1 and the second embodiment shown in FIG. 2.

FIG. 4 is a block diagram of a gas turbine combined-cycle power generation system which incorporates the fluidized-bed gasification apparatus shown in FIG. 1. In FIG. 4, air is compressed by an air compressor 50, and the compressed air and fuel are combusted in a combustor 51 to produce a high-temperature and high-pressure combustion gas. The temperature of the combustion gas is generally in the range of 1100 to 1300° C., but in recent years, such system in which the temperature of combustion gas is close to 1500° C. level has been developed and put to practical use. The high-temperature and high-pressure combustion gas is introduced into a gas turbine 52 and expanded therein, thus recovering power. Specifically, the gas turbine 52 is connected to a drive shaft of the air compressor 50 and a generator 53, and the air compressor 50 and the generator 53 are driven by the gas turbine 52, thus recovering power. The exhaust gas discharged from the gas turbine 52 with high temperature and a pressure of atmospheric pressure level, from which power has been recovered with expansion, is pressurized by a booster blower 4 and supplied to the fluidized-bed combustion furnace 1 as a fluidizing gas. The exhaust gas discharged from the fluidized-bed combustion furnace 1 is introduced to a waste heat boiler 54 through the reformer 5, and heat is recovered in the waste heat boiler 54 to generate steam. Thereafter, the exhaust gas is discharged from the waste heat boiler 54. The steam recovered in the waste heat boiler 54 drives a steam turbine 55 and generates electricity. Steam discharged from the steam turbine 55 is condensed in a condenser 56, and the condensed water is circulated through the waste heat boiler 54 by a supply pump 57. In the case where the fluidized-bed gasification apparatus shown in FIG. 2 or FIG. 3 is incorporated in the gas turbine combined-cycle power generation system, the exhaust gas discharged from the gas turbine 52 is supplied to the char combustion chamber 12 (see FIG. 2), or the char combustion chamber 12 and the heat recovery chamber 14 (see FIG. 3) as a fluidizing gas.

As described above, in the conventional gas turbine combined-cycle power generation system, the gas turbine exhaust has been utilized only for heat recovery to produce steam. According to the present invention, not only sensible heat of the gas turbine exhaust but also high-temperature residual oxygen in the gas turbine exhaust which has been never utilized can be effectively utilized for gasification of combustible materials. Therefore, in the process according to the present invention, the exergy loss can be greatly reduced, compared with the conventional gas turbine combined-cycle power generation system, and hence a true energy saving effect can be obtained.

### INDUSTRIAL APPLICABILITY

The present invention relates to a method and apparatus for effectively utilizing thermal energy possessed by a high-temperature combustion gas discharged from a combustor and utilizing high-temperature oxygen contained in the high-temperature combustion gas discharged from the combustor. The present invention can be utilized in a gas turbine combined-cycle power generation system which incorporates a fluidized-bed gasification apparatus.

1. A fluidized-bed gasification method for gasifying combustibles in a fluidized-bed furnace, comprising:
supplying exhaust gas discharged from a gas turbine in a power generation system to a fluidized-bed furnace as a fluidizing gas.

2. A fluidized-bed gasification method according to claim 1, further comprising reforming a produced gas produced in a gasification section in a reformer by bringing the produced gas into indirect contact with combustion exhaust gas discharged from a combustion section in said fluidized-bed furnace.

3. A fluidized-bed gasification apparatus for gasifying combustibles in a fluidized-bed furnace, comprising:
a gasification furnace for gasifying combustibles therein; and
a combustion furnace for combusting combustible components therein;
wherein a fluidized medium moves between said gasification furnace and said combustion furnace, and exhaust gas discharged from another combustor is utilized as a fluidizing gas in said combustion furnace.

4. A fluidized-bed gasification apparatus according to claim 3, wherein said combustible components comprise residual components generated in a gasification reaction in said gasification furnace.

5. A fluidized-bed gasification apparatus according to claim 3 or 4, wherein a bed temperature in said combustion furnac is kept in the range of 600 to 1000° C.

6. A fluidized-bed gasification apparatus according to any one of claims 3 to 5, wherein a bed temperature in said gasification furnace is kept in the range of 550 to 900° C.

7. A fluidized-bed gasification apparatus according to any one of claims 3 to 6, further comprising a reformer for reforming the produced gas produced in said gasification furnace by bringing the produced gas into indirect contact with combustion exhaust gas discharged from said combustion furnace.

8. A fluidized-bed gasification apparatus according to claim 7, wherein said reformer is provided in said combustion furnace.

9. A fluidized-bed gasification apparatus according to claim 7 or 8, wherein said reformer is provided in a freeboard section of said combustion furnace.

10. A fluidized-bed gasification apparatus for gasifying combustibles in a fluidized-bed furnace, comprising:
a fluidized-bed furnace having a gasification chamber for gasifying combustibles therein and a char combustion chamber for combusting combustible components therein; and
a partition wall for partitioning said gasification chamber and said char combustion chamber, said partition wall having an opening for allowing a fluidized medium to pass therethrough;
wherein an upper end of said opening is lower than a height of a fluidized b d, and xhaust gas discharged from another combustor is utilized as a fluidizing gas for said char combustion chamber.

11. A fluidized-bed gasification apparatus according to claim 10, wherein said combustible components comprise residual components generated in a gasification reaction in said gasification chamber.

12. A fluidized-bed gasification apparatus according to claim 10 or 11, further comprising:
a heat recovery chamber adjacent to said char combustion chamber;
a partition wall provided between said char combustion chamber and said heat recovery chamber for partitioning only a fluidized bed section; and
an opening formed in said partition wall between said char combustion chamber and said heat recovery chamber;
wherein the fluidized medium in said char combustion chamber flows into said heat recovery chamber beyond an upper end of said partition wall between said char combustion chamber and said heat recovery chamber, and is returned to said char combustion chamber through said opening formed in said partition wall between said char combustion chamber and said heat recovery chamber, thus creating a circulating flow of the fluidized medium.

13. A fluidized-bed gasification apparatus according to any one of claims 10 to 12, further comprising:
a fluidized medium moving chamber provided between said char combustion chamber and said gasification chamber;
a partition wall provided between said char combustion chamber and said fluidized medium moving chamber for partitioning only a fluidized bed section; and
a partition wall provided between said gasification chamb r and said fluidized medium moving chamber and having an opening near a furnace bottom.

14. A fluidized-bed gasification apparatus according to any one of claims 10 to 13, wherein a bed temperature in said char combustion chamber is kept in the range of 600 to 1000° C.

15. A fluidized-bed gasification apparatus according to any one of claims 10 to 14, wherein a bed temperature in said gasification chamber is kept in the range of 550 to 900° C.

16. A fluidized-bed gasification apparatus according to any one of claims 10 to 15, further comprising a reformer for reforming the produced gas produced in said gasification chamber by bringing the produced gas into indirect contact with combustion exhaust gas discharged from said char combustion chamber.

17. A fluidized-bed gasification apparatus according to claim 16, wherein said reformer is provided in said char combustion chamber.

18. A fluidized-bed gasification apparatus according to claim 16 or 17, wherein said reformer is provided in a freeboard section of said char combustion chamber.

19. ( ) A fluidized-bed char combustion apparatus comprising:
a char combustion chamber having a fluidized bed in which an internally circulating flow of a fluidized medium is formed; and
a combustor for generating exhaust gas and supplying the exhaust gas to said char combustion chamber as a fluidizing gas for fluidizing said fluidized medium.
